(19) United States
(12) Patent Application Publication
(10) Pub. No.: US 2026/0014896 A1
(43) Pub. Date: Jan. 15, 2026

(54) APPARATUS FOR PREDICTING ENERGY CONSUMPTION, SYSTEM FOR PREDICTING ENERGY CONSUMPTION, METHOD FOR PREDICTING ENERGY CONSUMPTION, AND NON-TRANSITORY STORAGE MEDIUM STORING PROGRAM FOR PREDICTING ENERGY CONSUMPTION

(71) Applicant: Isuzu Motors Limited, Yokohama-shi (JP)

(72) Inventor: Keita ARATO, Fujisawa-shi (JP)

(73) Assignee: Isuzu Motors Limited, Yokohama-shi (JP)

(21) Appl. No.: 19/238,218

(22) Filed: Jun. 13, 2025

(30) Foreign Application Priority Data
Jul. 12, 2024 (JP) 2024-112535

(51) Int. Cl. B60L 58/10

(52) U.S. Cl. CPC B60L 58/10; B60L 2240/12; B60L 2240/26; B60L 2240/642; B60L 2240/647; B60L 2260/54

(57) ABSTRACT

An apparatus for predicting energy consumption, includes a processor which is configured to: acquire information indicating a scheduled moving route of a vehicle; specify a running resistance that will be applied to the vehicle when the vehicle moves on the scheduled moving route, based on the information indicating the scheduled moving route; specify a moving output that will be required for driving of a driving source of the vehicle when the vehicle moves on the scheduled moving route, based on the information indicating the scheduled moving route; and output, based on the running resistance and the moving output, an amount of energy consumption when the vehicle moves on the scheduled moving route.

### CROSS REFERENCE TO RELATED APPLICATIONS

This application is based upon and claims the benefit of priority from prior Japanese Patent Application No. 2024-112535, filed Jul. 12, 2024, the entire contents of which are incorporated herein by reference.

### FIELD

The present invention relates to an apparatus for predicting energy consumption, a system for predicting energy consumption, a method for predicting energy consumption, and a non-transitory storage medium storing a program for predicting energy consumption.

### BACKGROUND

A vehicle receives various resistances during moving. There is a demand for predicting energy consumption of a vehicle so as to be able to perform operation schedule planning, charging management, etc. Japanese Patent KOKAI Publication No. 2014-202643 discloses calculating an amount of moving power consumption of an electric vehicle based on acceleration usage rate data corrected with power consumption amount data and course information, which change over the duration of moving.

### SUMMARY

According to one aspect of the present invention, an apparatus for predicting energy consumption, includes a processor which is configured to: acquire information indicating a scheduled moving route of a vehicle; specify a running resistance applied to the vehicle at a time of moving of the vehicle on the scheduled moving route based on the information indicating the scheduled moving route; specify a moving output required for driving of a driving source of the vehicle at the time of moving of the vehicle on the scheduled moving route based on the information indicating the scheduled moving route; and output, based on the running resistance and the moving output, an amount of energy consumption at the time of moving of the vehicle on the scheduled moving route.

### BRIEF DESCRIPTION OF THE DRAWINGS

FIG. 1 is a schematic diagram showing a schematic configuration of a system for predicting energy consumption of a vehicle according to an embodiment.

FIG. 2 is a schematic diagram showing a waste collection vehicle (garbage truck/dustcart) as an example of the vehicle.

FIG. 3A is a graph showing a relationship between an operation time of a mounting on the vehicle and a weight of waste.

FIG. 3B is a graph showing a relationship between an operation time of the mounting on the vehicle and an amount of energy consumption of the mounting during waste collection.

FIG. 3C is a graph showing a relationship between an operation time of the mounting on the vehicle and an amount of energy consumption of the mounting during waste discharging.

FIG. 4 is a diagram showing a processing flow of the system shown in FIG. 1.

FIG. 5 is a schematic diagram illustrating the processing flow of FIG. 4.

### DETAILED DESCRIPTION

Embodiments of the present invention will be explained referring to the drawings.

In the embodiments, it is assumed that the terms “waste”, “trash”, “garbage”, “rubbish”, “litter”, “refuse”, etc., used to refer to what is generally known as waste. That is, in the embodiments, “waste” intends to include “trash”, “garbage”, “rubbish”, “litter”, “refuse”, and the like.

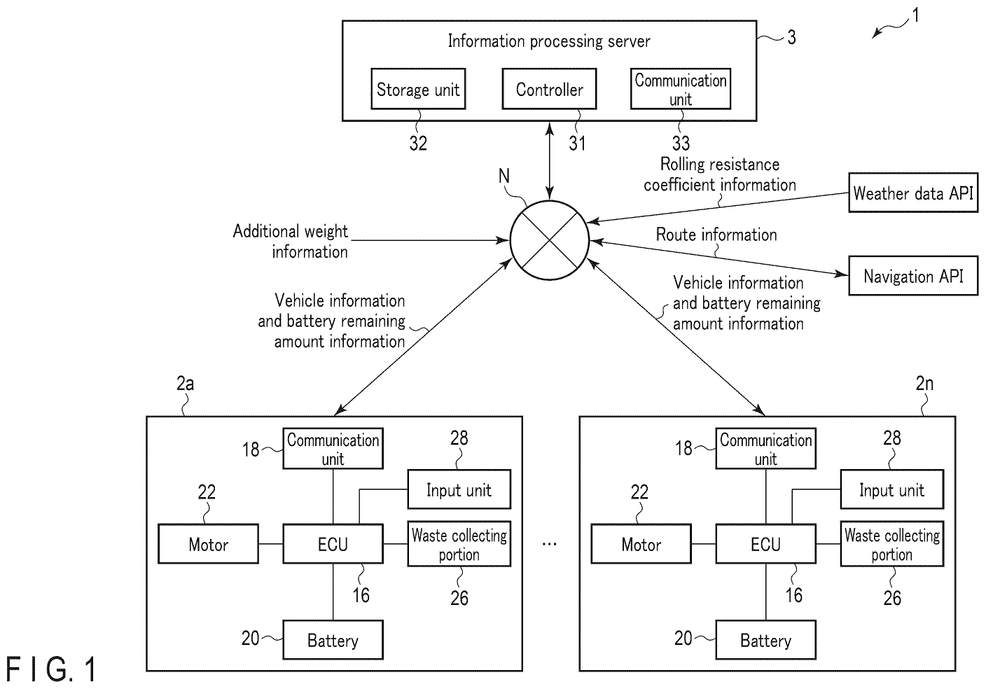

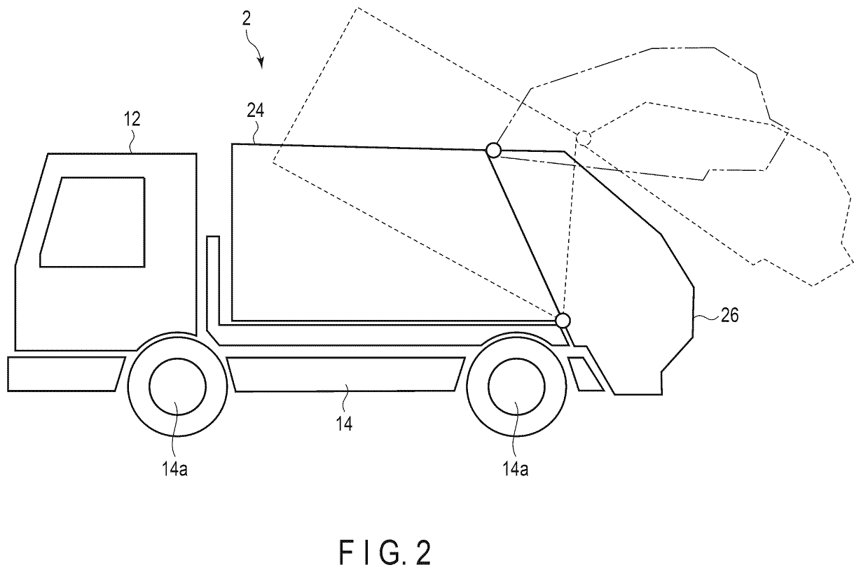

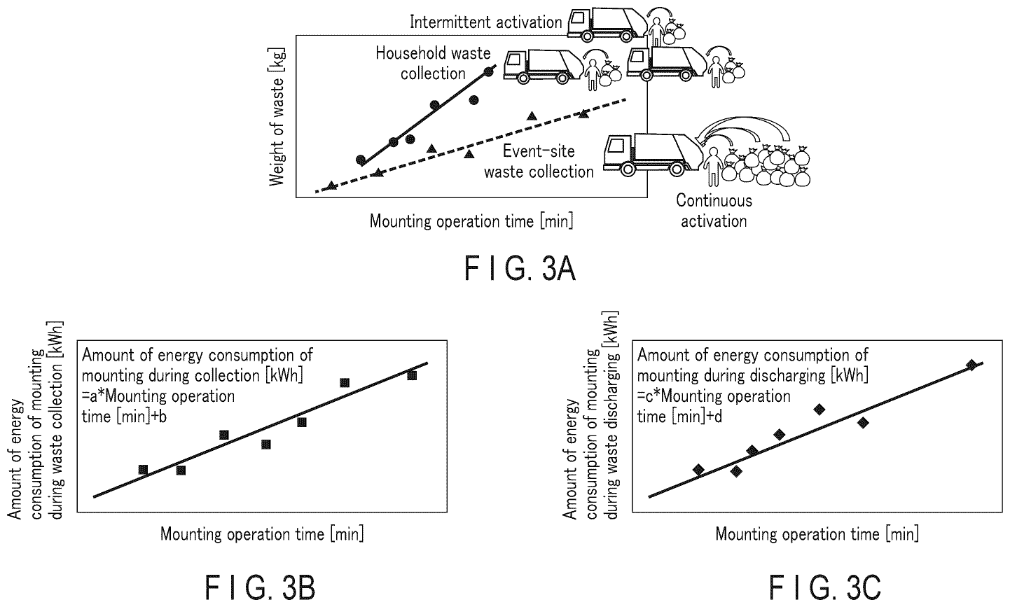

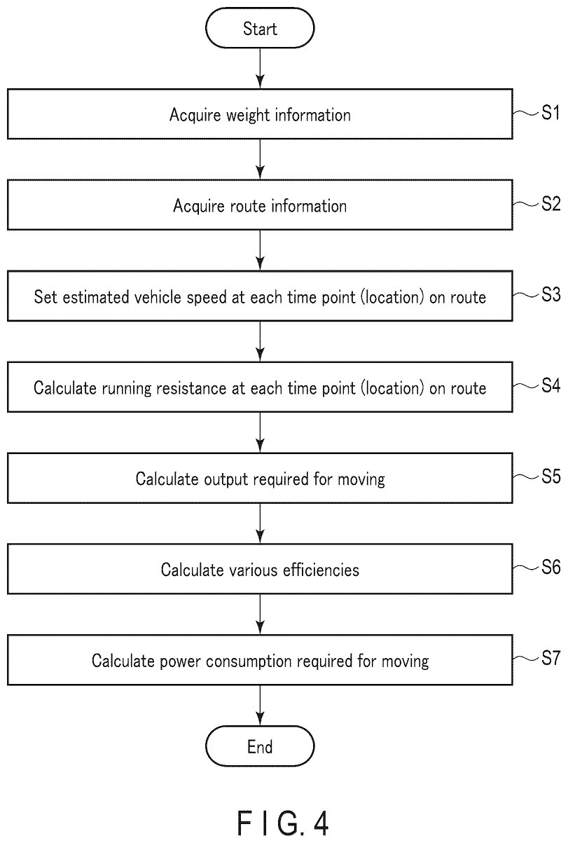

FIG. 1 is a schematic configuration diagram of a system 1 for predicting energy consumption (hereinafter mainly referred to as a “system”) of a vehicle 2 according to an embodiment of the present invention. FIG. 2 is a schematic diagram showing an example of the vehicle 2 including a mounting. FIG. 3A is a graph showing a relationship between an operation time of the mounting on the vehicle 2 and a weight of waste. FIG. 3B is a graph showing a relationship between an operation time of the mounting on the vehicle 2 and an amount of energy consumption of the mounting during waste collection. FIG. 3C is a graph showing a relationship between the operation time of the mounting on the vehicle 2 and the amount of energy consumption of the mounting during waste discharging. FIG. 4 shows a processing flow of the system 1.

As shown in FIG. 1, the system 1 includes n vehicles 2a to 2n (where n is an integer equal to or greater than 1) and an information processing server (an apparatus for predicting energy consumption of the vehicle) 3 configured to communicate with the vehicles 2a to 2n via a network N.

In the description that follows, the n vehicles 2a to 2n will be simply referred to as “vehicles 2” with the individual symbols omitted if they do not need to be distinguished from one another. As a matter of course, it is preferable that the vehicles 2a to 2n be the same type of vehicles with the same mounting; however, they may be different types of vehicles with the same mounting.

It is preferable that the vehicle 2 include a mounting, in addition to a cab 12 and a chassis 14. The vehicle 2 is, for example, a cargo truck, a waste collection vehicle, or the like. Examples of the cargo truck include a flatbed, a van, a dump truck, a tractor-trailer, etc. A total weight of the vehicle 2 of these types may be varied by, for example, loading/unloading of freight, waste, and the like onto/from the vehicle 2.

In the present embodiment, a case will be mainly described where the vehicle 2 is a waste collection vehicle; however, any vehicle 2 whose total weight may change in accordance with storage and/or withdrawal of articles, such as a delivery vehicle, may be used.

As shown in FIGS. 1 and 2, the vehicle 2 includes, in addition to the cab 12 and the chassis 14, an electronic control unit (ECU) 16, a communication unit 18, a battery 20, a motor 22, a waste storing portion 24, a waste collecting portion 26, and an input unit 28.

Permissible examples of the vehicle 2 according to the present embodiment include an electric vehicle (EV) and an engine vehicle such as a diesel engine vehicle, a hybrid electric vehicle (HEV), a plug-in hybrid electric vehicle (PHEV), and a fuel cell electric vehicle (FCEV). It is assumed herein that the vehicle 2 is an EV, and the ECU 16, the communication unit 18, the battery 20, the motor 22, the waste storing portion 24, and the waste collecting portion 26 are disposed in the chassis 14. Of these elements, the waste storing portion 24 and the waste collecting portion 26 are disposed as a mounting on the truck.

The ECU 16 is a computer (controller) of the vehicle 2 configured to control each element of the vehicle 2. The ECU 16 controls the entire operation of the vehicle 2 in accordance with a program stored in a storage unit of the ECU 16. The ECU 16 is configured of, for example, electronic circuitry such as one or more processors, such as CPUs. The ECU (processor) 16 executes various programs stored in the storage unit of the ECU 16 to realize corresponding functions and execute various operations.

The vehicle 2 may include either a single ECU 16 or a plurality of ECUs 16, for example, an ECU for controlling elements related to the vehicle moving and an ECU for controlling the mounting such as the waste collecting portion 26. For ease of explanation, a case is assumed herein, as an example, where a single ECU 16 is provided in the vehicle 2. In the case where the plurality of ECUs 16 are divided into the one for controlling the elements related to the vehicle traveling and the one for controlling the mounting such as the waste collecting portion 26, the vehicle 2 is controlled in a similar manner to the case of the single ECU 16.

The communication unit 18 transmits and receives various information signals related to the vehicle 2 to and from a server or computer 3 of the system 1 via the network N.

The battery 20 supplies, to the ECU 16, the communication unit 18, the motor 22, the waste collecting portion 26, etc., a suitable amount of power to be controlled by the ECU 16.

The motor 22 is used as a drive source for driving the wheels 14a of the vehicle 2 by power from the battery 20.

The waste storing portion 24 is, for example, provided between the cab 12 and the waste collecting portion 26. The waste storing portion 24 is formed as a container for storing waste.

The waste collecting portion 26 operates a hydraulic device of the waste collecting portion 26 by power from the battery 20, and causes the waste storing portion 24 to store waste. Also, the waste collecting portion 26 operates the hydraulic device of the waste collecting portion 26 by power from the battery 20, and causes the waste to be discharged to the outside of the vehicle 2 from the waste storing portion 24. Thus, the waste collecting portion 26 can switch between a mode of storing waste in the waste storing portion 24 and a mode of discharging waste put into the waste storing portion 24 to the outside. In the present embodiment, for ease of explanation, it is assumed that, in either mode of operation, the hydraulic device of the waste collecting portion 26 is operated by a pressing-down of a switch of the waste collecting portion 26.

As a mechanism by which the waste collecting portion 26 stores waste in the waste storing portion 24, any one of the known methods such as a rotating type (rotating-plate type), a pressing type (pressure-plate type), a rotary type that uses a drum, or the like may be used. In the present embodiment, it is assumed that the rotary type is used as a mechanism for the waste collecting portion 26 in the collecting mode.

At a waste incineration plant, etc., the waste storing portion 24 and the waste collecting portion 26 may be disposed at, for example, the positions shown by the dashed lines, or the waste collecting portion 26 may be disposed at, for example, the position shown by the two-dot chain line, such that the waste stored in the waste storing portion 24 can be easily discharged.

In the present embodiment, it is assumed that a mounting (e.g., the hydraulic device of the waste collecting portion 26) on the vehicle 2 is driven to sequentially discharge the waste stored in the waste storing portion 24 to the outside of the vehicle 2. As a mechanism by which the waste is discharged from the waste storing portion 24, any one of the known methods such as the rotary type that inversely rotates a drum, a pushing type that moves a pusher plate (not illustrated), and a dump type that lifts the waste storing portion 24 using, for example, a hoist mechanism (not illustrated) may be used.

In the case of using, for example, the dump type, the waste storing portion 24 is tilted using the hoist mechanism, and the waste collecting portion 26 is rotated relative to the waste storing portion 24 to open the waste storing portion 24 and discharge waste therefrom. In the case of using, for example, the dump type, the waste storing portion 24 and the waste collecting portion 26 of the vehicle 2 move between the position indicated by the solid line and the position indicated by the dashed line in FIG. 2. In the case of using the pushing type, the waste collecting portion 26 is rotated relative to the waste storing portion 24 to open the waste storing portion 24 and discharge waste with the pusher plate, as shown by the two-dot chain line in FIG. 2.

In the present embodiment, the input unit 28 is used for an input to select a mode from among selection modes (e.g., a first mode for collecting household waste, a second mode for collecting waste at an event site, and a third mode for other purposes). The input unit 28 should be provided in, for example, the cab 12, the waste storing portion 24, or the waste collecting portion 26. Also, an information terminal such as a smartphone carried by a worker may be used as, for example, an input unit 28 that is connected via the communication unit 18.

In the first mode, it is assumed that the mounting (the hydraulic device of the waste collecting portion 26) on the vehicle 2 is intermittently activated to collect waste at a plurality of spots in a series of waste collection procedures, by repeating driving of the hydraulic device of the waste collecting portion 26 for an activation time shorter than a predetermined period of time at each spot.

In the second mode, it is assumed that the mounting (the hydraulic device of the waste collecting portion 26) on the vehicle 2 is continuously activated for a period of time equal to or longer than a predetermined period of time, or is intermittently activated for an activation time shorter than the predetermined period of time by moving the vehicle 2 within a predetermined distance range, thereby collecting waste. In the second mode, if the mounting is intermittently activated, the amount of movement of the vehicle 2 is set to a predetermined value or below.

The worker of the vehicle 2 drives the vehicle 2 to move it to a predetermined number of (e.g., one or more than one) locations of waste collection, and drives the hydraulic device of the waste collecting portion 26 to cause the waste storing portion 24 to store waste at each spot where the vehicle 2 is stopped. Also, the worker drives the vehicle 2 to move it to, for example, a predetermined waste incineration plant, etc., and drives the hydraulic device of the waste collecting portion 26 to discharge waste put into the waste storing portion 24 to the outside at the waste incineration plant, etc. where the vehicle 2 is stopped. In this manner, the vehicle 2 consumes power from the battery 20, for example, at the time of moving to one or more spots for waste collection, at the time of moving to a waste incineration plant, etc. for waste discharging after the waste collection, and at the time of operation (collection and discharging) of the waste collecting portion 26.

Here, a running resistance Rₜₒₜₐₗ(N) at the time of movement of the vehicle 2 can be expressed by the following Formula (1):

$${R}_{total} = {R}_{r} + {R}_{a} + {R}_{g} + {R}_{i} \qquad ( 1 )$$

Here, Rr(N) is a rolling resistance, Ra(N) is an air resistance, Rg(N) is an inclination resistance, and Ri(N) is an acceleration resistance. Due to the running resistance Rₜₒₜₐₗ, the vehicle 2 consumes power from the battery 20 at the time of movement (traveling).

The rolling resistance Rr denotes mainly a resistance generated mainly by energy loss due to deformation of tires of the vehicle 2. The rolling resistance Rr can be expressed by the following Formula (2):

$${R}_{r} = {μ}_{r} {m}_{test} \qquad ( 2 )$$

It is assumed herein that μᵣ is a rolling resistance coefficient, which herein includes a gravitational acceleration g (m/s²). The rolling resistance coefficient μᵣ is affected by, for example, the situation of the road surface (the material with which the road is paved, whether the road is dry or wet, etc.), the tires (the type, the air pressure, etc.), the wheel weight, the state of the axle (the temperature of the grease), etc. Here, mₜₑₛₜ is a total weight (kg) of the vehicle 2 including the mounting, the freight, and the waste. It is preferable that the total weight include the weight, etc. of the worker who sits in and moves the vehicle 2. The rolling resistance Rr increases in proportion to the total weight of the vehicle 2. The rolling resistance Rr is affected not only by the weight of the vehicle 2 itself, but also by the weights of the freight and the waste.

The air resistance Ra denotes a resistance generated by a friction between the air and the surface of the vehicle 2 including the mounting. The air resistance Ra can be expressed by the following Formula (3):

$${R}_{a} = {μ}_{a} {v}_{x}^{2} \qquad ( 3 )$$

Here, μₐ denotes a coefficient obtained by multiplying an air resistance coefficient (N·m⁻²·(km/h)⁻²) by a frontal projected area (m²) of the vehicle 2. Accordingly, μₐ changes according to the frontal shape (the cab 12, the chassis 14, and the mounting (e.g., the waste storing portion 24, etc.) of the vehicle 2. Also, vₓ denotes a moving speed (km/h) of the vehicle 2. The air resistance Ra increases in proportion to a square of the vehicle speed.

It can thus be seen that, the faster the speed of the vehicle 2, the greater the power consumption during moving.

The inclination resistance Rg denotes, for example, a resistance generated at the time of climbing, for example. The inclination resistance Rg can be expressed by the following Formula (4):

$${R}_{g} = {m}_{test} g sin β \qquad ( 4 )$$

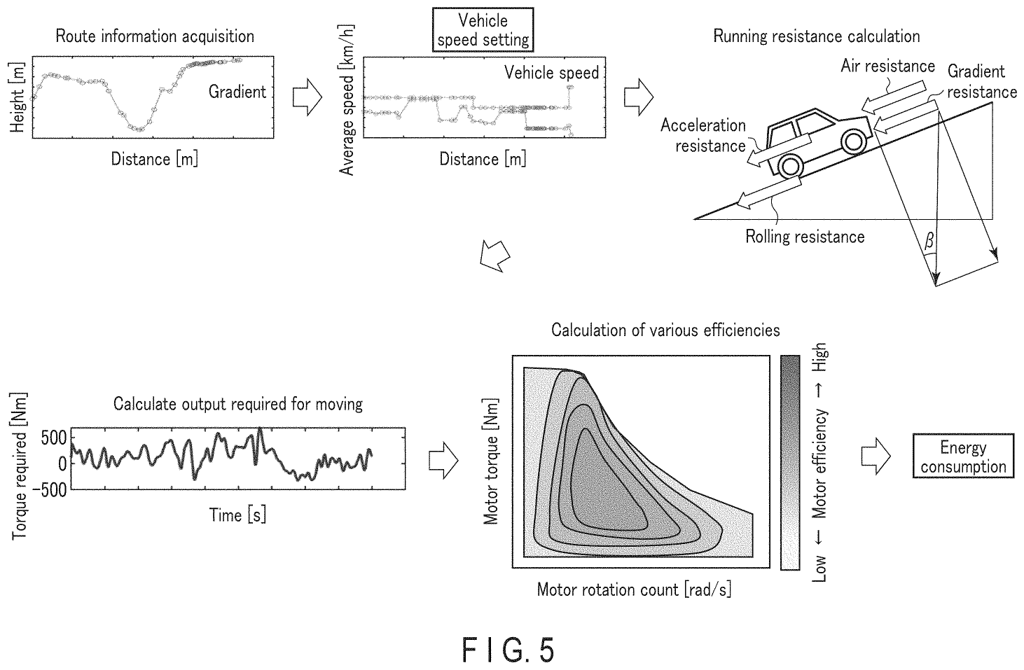

Here, mₜₑₛₜ denotes a total weight (kg) of the vehicle 2 including the mounting, the freight, and the waste of the vehicle 2, where g denotes a gravitational acceleration (m/s²), and β of sin β (see FIG. 5) denotes an inclination angle of a road surface relative to a horizontal surface. The inclination resistance Rg is proportional to the total weight of the vehicle 2 and the sin β of the inclination angle β. The inclination resistance Rg is thus affected not only by the weight of the vehicle 2 itself, but also by the weights of the freight and the waste. The inclination resistance Rg changes according to a change in gradient of the position at which the vehicle 2 moves. It can thus be seen that, the greater the weight of the freight and the waste and the greater the gradient while the vehicle 2 is moving, the greater the power consumption during moving.

The acceleration resistance Ri denotes a resistance generated at the time of acceleration. The acceleration resistance Ri can be expressed by the following formula (5):

$${R}_{i} = ( {m}_{test} + Δ {m}_{drv + eng} ) {\dot{v}}_{x} \qquad ( 5 )$$

Here, mₜₑₛₜ is a total weight (kg) of the vehicle 2 including the mounting, the freight, and the waste, and Δm_{drv+eng} is an inertia equivalent mass (kg) of rotating portions of a drive mechanism. The inertia equivalent mass can be obtained by converting, into weights, inertia forces of the rotating portions of the drive mechanism, namely, an engine, a transmission, a propeller shaft, a differential gear, and rear wheels, which need to be accelerated at the time of acceleration of the vehicle. Here, vₓ denotes a vehicle moving speed (km/h), and denotes an acceleration in Formula (5). The acceleration resistance Ri is proportional to the acceleration and the weight of the vehicle 2. The acceleration resistance Ri is affected not only by the weight of the vehicle 2 itself, but also by the weights of the freight, the waste, etc.

The running resistance Rₜₒₜₐₗ while the vehicle 2 is moving is thus affected not only by the weights of the vehicle 2 itself and the worker, but also by the weights of the freight and the waste. As a matter of course, the larger the running resistance Rₜₒₜₐₗ, the greater the power consumption (energy) during moving (during traveling) of the vehicle 2, resulting in lower power efficiency.

FIG. 1 is a block diagram schematically showing a configuration example of an information processing server 3 according to the present embodiment.

The server 3 is a computer including a controller 31, a storage unit 32, and a communication unit 33. The controller 31, the storage unit 32, and the communication unit 33 are mutually connected via a bus line.

The controller 31 controls the entire operation of the information processing server 3 in accordance with programs stored in the storage unit 32. The controller 31 is configured of, for example, electronic circuitry such as one or more processors. It is assumed, for example, that the controller 31 is a CPU. The controller 31 executes various programs stored in the storage unit 32 to realize corresponding functions and execute various operations.

The storage unit 32 is configured of a main storage and an auxiliary storage. The main storage is configured of, for example, a volatile memory that provides a work area for a processor. The main storage is configured of, for example, a random access memory (RAM), etc. The auxiliary storage is, for example, a non-transitory storage medium, and is configured of, for example, a nonvolatile memory configured to store a variety of information and programs for operation of the information processing server 3. The auxiliary storage is configured of, for example, a hard disk drive (HDD) or a solid-state drive (SSD). The storage unit 32 causes the controller 31 to store programs for realizing various functions. In the present embodiment, the storage unit 32 is configured, for example, to store an energy consumption prediction program of the vehicle 2, which is executed by the controller 31. The server 3 acquires information on the relationships shown in the graphs of FIGS. 3A to 3C provided through the network N, for example, and then causes the storage unit 32 to store the acquired information. It is preferable that, after a series of waste collection procedures have ended, the server 3 measure a weight of the vehicle 2 at, for example, a waste incineration plant, etc., acquire a relationship between an accumulated operation time of the mounting and weight information of the waste from at least some of the vehicles 2a to 2n, and update information of the graphs shown in FIGS. 3A to 3C stored in the storage unit 32.

FIG. 3A shows a graph in which the lateral axis represents an operation time of the waste collecting portion 26 as a mounting, and the vertical axis represents a weight of the waste. The information shown in FIG. 3A is an example of information obtained by actually collecting household waste at a plurality of spots on a route, or by collecting waste after completion of an event at a location or a facility. In the case of household waste, it is preferable that such data be provided for the respective waste types into which the waste is sorted, although such sorting differs according to the local government.

The operation time of the waste collecting portion 26 is a period of time during which the hydraulic device of the waste collecting portion 26 has been operated using power from the battery 20 in response to a pressing-down of the switch of the waste collecting portion 26 by a waste collecting worker. In the case of collecting household waste, for example, the hydraulic device of the waste collecting portion 26 is continuously activated at each collection spot; however, the hydraulic device of the waste collecting portion 26 is not usually maintained in an activated state while the vehicle moves to the next point, and is intermittently activated in most cases, namely, activated at each collection spot and then stopped and moved to the next spot. On the other hand, in the case of collecting waste at an event site, for example, the hydraulic device of the waste collecting portion 26 is continuously activated in most cases.

It can be seen, from the graph shown in FIG. 3A, that, in the case of household waste collection (first mode), there is a tendency for the weight to increase in a short period of operation time of the hydraulic device of the waste collecting portion 26, compared to the case of the event-site waste collection (second mode). However, such a tendency is shown merely as an example, and may change according to the type, etc. of waste. The household waste can be sorted into, for example, plastics, PET bottles, metals, paper, and others, although such sorting differs according to the local government. Thus, the weight of waste collected by the vehicle 2 may change according to the type of waste and the day of the week of collection. On the other hand, the event-site waste can be sorted into, for example, PET bottles, paper containers for eating and drinking, plastic containers for eating and drinking, and others. Also, the weight of the waste collected by the vehicle 2 changes according to the products, etc. being sold at the event site.

The graph shown in FIG. 3B represents a relationship of an amount of energy consumption during waste collection relative to an operation time of the mounting on the waste collection vehicle functioning as the vehicle 2, and the graph shown in FIG. 3C represents a relationship of an amount of energy consumption during waste discharging relative to an operation time of the mounting on the waste collection vehicle functioning as the vehicle 2.

The communication unit 33 is configured of one or more communication interfaces capable of performing communications compliant with a given wireless communication standard. The communication unit 33 includes one or more communication interfaces that enable communications between the information processing server 3 and the vehicle 2 via the network N, as described above.

A hardware configuration of the information processing server 3 is not limited to the above-described one. The above-described constituent elements of the information processing server 3 can be suitably omitted and/or altered; furthermore, new constituent elements may be suitably added.

The system 1 is what is known as a client-server system. The system 1 is realized through mutual communication between the server 3 and the ECU 16 of each of n vehicles 2, which are clients, via the network N and the communication units 18 and 33. Note that the network N is realized by a network such as the Internet, a mobile telephone network, or a local area network (LAN), or a network that is a combination of them.

The server 3 can receive information from a navigation Application Programming Interface (API) and a weather data API via the network N, for example, for use in processing with various programs. Also, the server 3 can selectively acquire, as additional weight information, the relationships shown in the graphs of FIGS. 3A to 3C via the network N for use in processing with various programs.

A process of calculating energy consumption required for desired moving of the vehicle 2 as realized by the controller 31 of the information processing server 3 will be described with reference to FIG. 4. Each of the processes being realized by the controller 31 may also be said to be realized by a computer including a processor.

It is assumed, for example, that the vehicle 2 inputs, to the input unit 28, information that the vehicle 2 is expected to arrive at point B from point A (distance 0) while collecting waste. The ECU 16 of the vehicle 2 transmits the information input to the input unit 28 to the controller 31 of the server 3. The controller 31 of the server 3 specifies a vehicle 2 for which a process of predicting an amount of energy consumption required for desired moving is performed, and acquires information on the remaining amount of the battery 20 of the specified vehicle 2 and vehicle information such as information that affects a running resistance (step S1). In other words, the ECU (controller) 16 is provided in the vehicle 2, and transmits the states of the motor (driving source) 22 for rotating the wheels 14a and the battery 20 for supplying energy to drive the motor 22 to the server (apparatus) 3 for predicting energy consumption of the vehicle 2. Note that the information that affects the running resistance of the vehicle 2 is, for example, a current total weight (including the weight of the driver) of the vehicle 2, a frontal projected area of the vehicle 2, an inertia equivalent mass of the rotating portions of the drive mechanism of the vehicle 2, etc.

The controller 31 of the server 3 obtains, from the navigation API, information on a route on which the vehicle is scheduled to move (information indicating a scheduled moving route of the vehicle 2) (step S2). The route information includes map information, gradient information (elevation change information), congestion information, and a speed limit of the scheduled moving route. The route information contains information (arrival time prediction information) on time t2 at which the vehicle 2 arrives at point B after departing point A (distance 0) at time t1.

The controller 31 of the server 3 is configured to calculate, based on the route information, vehicle speed information for a section from point A (distance 0) to point B, and to set a vehicle speed at each point on the route (step S3).

Also, the controller 31 of the server 3 acquires the information that affects the running resistance Rₜₒₜₐₗ from a suitable API. For example, the controller 31 of the server 3 obtains, from the weather API, weather information that may affect the road surface situation, etc. on the route acquired via the navigation API. Also, the controller 31 of the server 3 predicts a degree of increase in waste weight using, for example, the relationship shown in the graph of FIG. 3A and information on the predicted operation time of the mounting (waste collecting portion 26) at each location of waste collection. The controller 31 of the server 3 acquires information on operation of the vehicle via, for example, the network N, and calculates prediction information on the weight or the weight change of the vehicle 2.

The controller 31 of the server 3 calculates a rolling resistance Rr based on Formula (2), an air resistance Ra based on Formula (3), a inclination resistance Rg based on Formula (4), and an acceleration resistance Ri based on Formula (5), and calculates a running resistance Rₜₒₜₐₗ based on Formula (1). The total weight of the vehicle 2 that affects the running resistance Rₜₒₜₐₗ changes according to, for example, the waste collected at each location of collection. The gradient and the road surface situation on the route that affect the running resistance Rₜₒₜₐₗ change according to the position. Accordingly, the running resistance Rₜₒₜₐₗ is given as a function of time, which changes according to time (step S4). That is, the controller 31 of the server 3 specifies a running resistance that will be applied to the vehicle 2 when the vehicle 2 moves on the scheduled moving route, based on information indicating the scheduled moving route.

The controller 31 of the server 3 calculates an output that will be required for the vehicle 2 to move from point A to point B (step S5). That is, the controller 31 of the server 3 specifies a moving output that will be required for driving the motor 22, which is a driving source of the vehicle 2 when the vehicle 2 moves on the scheduled moving route based on the information indicating the scheduled moving route. Accordingly, the controller 31 of the server 3 calculates a moving output that will be required for driving the motor (driving source) 22 for rotating the wheels 14a of the vehicle 2 to obtain an estimated vehicle speed when the vehicle 2 moves on the scheduled moving route. In the graph showing “Calculation of output required for moving” in FIG. 5, the lateral axis represents a scheduled time point when the vehicle 2 is expected to arrive at point B from point A, and the vertical axis represents a torque required at each time point of the motor 22 used as a driving source for driving the wheels 14a.

The controller 31 of the server 3 acquires, for example, a type and an age of usage of the motor 22 of the vehicle 2, and a distance traveled (a cumulative rotation count) using the motor 22 at the time of acquiring vehicle information of the vehicle 2. In the graph showing “Calculation of Various Efficiencies” shown in FIG. 5, for example, the lateral axis represents a rotation count per unit time [rad/s] of the motor 22, and the vertical axis represents a torque [Nm] of the motor 22. Such a characteristic (motor efficiency) changes according to the type, the age of usage, the distance traveled, etc. of the motor 22. The controller 31 of the server 3 calculates the motor efficiency of the motor 22 as, for example, a suitable coefficient (step S6). Note that, if such a coefficient uses the motor efficiency of the motor 22, for example, the controller 31 of the server 3 can determine the coefficient for each vehicle 2.

At step S6, the server 3 calculates various efficiencies. The calculation of such efficiencies include, for example, calculating a relationship of an amount of energy consumption of a mounting on the vehicle 2 in accordance with an operation of the mounting on the vehicle 2, as shown in FIG. 3B, and/or calculating an effect caused by a relationship of the amount of energy consumption of the mounting at the time of discharging waste to the outside of the vehicle 2 from the mounting on the vehicle 2 in accordance with an operation of the mounting on the vehicle 2, as shown in FIG. 3C. Thus, an expected operation time of the mounting on the vehicle 2 and an expected amount of energy consumption of the mounting in accordance with the expected operation time in the case where the vehicle 2 is a waste collection vehicle are calculated. Accordingly, at step S6, the controller 31 of the server 3 calculates various efficiencies as suitable functions, etc., based on, for example, the energy amount of the mounting on the vehicle 2 in addition to the motor efficiency of the motor 22.

The controller 31 of the server 3 calculates an amount of energy consumption that will be required for the vehicle 2 to, for example, reach point B from point A using the output required for moving acquired at step S5 and the coefficient calculated at step S6 (step S7). It is preferable that the predicted amount of energy consumption be output as a single value; however, the coefficient calculated at step S6 may include an unknown condition of the vehicle 2 and be output as a suitable range of values. In the case where the vehicle 2 is a waste collection vehicle and collects waste at a plurality of spots while moving from point A to point B, the amount of energy consumption calculated by the server 3 includes an amount of energy consumption required for driving the mounting on the vehicle 2, in addition to an amount of energy required for moving in which an effect of the running resistance is reflected.

By causing the controller 31 of the server 3 to precisely estimate a total weight including a weight change of the vehicle 2, a gradient of the scheduled moving route, and a vehicle speed on the scheduled moving route with high precision and using the estimated values for predicting (calculating) the amount of energy consumption, it is possible to improve the precision of predicting of energy consumption of the vehicle 2. It is thereby possible for the administrator of the vehicle 2 to realize a high-precision operation schedule (with an optimized course) of the vehicle 2 using the server (apparatus) 3 for predicting energy consumption of the vehicle 2, leading to reduction in the operation cost of the vehicle 2 and a cutting down of energy consumption.

Based on the calculated amount of energy consumption and the currently remaining amount of the battery 20, the controller 31 of the server 3 is capable of outputting information as to whether or not the vehicle 2 can arrive at point B from point A along the route on which the vehicle 2 is scheduled to move without performing charging, etc. of the battery 20. Thus, the user of the server 3 can perform energy management of the vehicle 2. If the controller 31 of the server 3 has determined that the vehicle 2 cannot arrive at point B from point A along the route on which the vehicle 2 is scheduled to move without performing charging, etc. of the battery 20, it is possible to perform charging management to introduce, as a stopover, a new charging facility where the battery 20 of the vehicle 2 can be charged in the section between point A to point B. If a plurality of charging facilities are provided, the controller 31 of the server 3 is capable of outputting (proposing), as a stopover, an optimum charging facility in consideration of a total weight including a weight change of the vehicle 2, a gradient of the scheduled moving route, and an estimated vehicle speed on the scheduled moving route.

According to the present embodiment, it is thus possible to provide an apparatus or server 3 for predicting energy consumption of the vehicle 2, a system 1 for predicting energy consumption of the vehicle 2, a method for predicting energy consumption of the vehicle 2, and a non-transitory storage medium storing a program for predicting energy consumption of the vehicle 2 capable of more accurately predicting energy consumption of the vehicle 2.

In the present embodiment, an example of calculating a running resistance including a rolling resistance of tires of the vehicle, an air resistance of the vehicle, a inclination resistance generated at a time of climbing of the vehicle, and an acceleration resistance generated at a time of acceleration of the vehicle, using prediction information on a weight of the vehicle 2, information on an elevation change of a scheduled moving route of the vehicle 2, an average vehicle speed calculated based on a distance of the scheduled moving route and an average time required, or an estimated vehicle speed calculated based on the distance of the scheduled moving route and an estimated time required. According to the present embodiment, by specifying the running resistance using at least one of the prediction information on the weight of the vehicle 2, the information on the elevation change of the scheduled moving route of the vehicle 2, or the vehicle speed calculated based on the distance of the scheduled moving route and the average time required or the estimated time required, it is possible to provide an apparatus or server 3 for predicting energy consumption of the vehicle 2, a system 1 for predicting energy consumption of the vehicle 2, a method for predicting energy consumption of the vehicle 2, and a non-transitory storage medium including a program for predicting energy consumption of the vehicle 2 capable of predicting energy consumption of the vehicle 2 with suitable precision. That is, not all of the prediction information on the weight of the vehicle 2, the information on the elevation change of the scheduled moving route of the vehicle 2, or the estimated vehicle speed calculated based on the distance of the scheduled moving route and the average time required or the estimated time required are necessarily required at the time of predicting energy consumption of the vehicle 2, and at least one of them is enough to contribute to improving the precision of predicting the energy consumption of the vehicle 2. It is preferable that the apparatus or server (processor) 3 for predicting energy consumption of the vehicle 2 specify the running resistance Rₜₒₜₐₗ based on at least one of: the distance of the scheduled moving route; the average time required or the estimated time required; or the average vehicle speed or the estimated vehicle speed. It is also preferable that the apparatus or server (processor) 3 for predicting energy consumption of the vehicle 2 specify the running resistance Rₜₒₜₐₗ based on at least two of: the information on the weight of the vehicle 2 when the vehicle 2 moves on the scheduled moving route; at least one of the distance of the scheduled moving route, the average time required or the estimated time required, or the average vehicle speed or the estimated vehicle speed; and at least one of an elevation or a road surface situation on the scheduled moving route.

Herein, an example has been described in which the vehicle 2 is a waste collection vehicle. However, the vehicle 2 may be, for example, a delivery vehicle. A brief description will be made, as an example, of the case where the vehicle (delivery vehicle) 2 departs from a parking location (point A) where the vehicle 2 parks, stops over at a distribution base (point B) where a large number of packets are loaded into the vehicle 2, delivers a first packet loaded into the vehicle 2 to a first delivery address or location of residence (point C), and delivers a second packet to a second delivery address or location of residence (point D).

Weights of the packets at the distribution base (point B) are, for example, measured or estimated at a system (facility) of a distribution warehouse, etc. Thus, the controller 31 of the server 3 can acquire a total weight of the large number of packets to be delivered by the vehicle 2 from the system, etc. of the distribution warehouse, and reflect the acquired weight in the running resistance Rₜₒₜₐₗ.

At step S1 of the flow shown in FIG. 4, the controller 31 of the server 3 acquires vehicle information of the vehicle 2, and acquires information on delivery destinations of a large number of packets to be loaded at a distribution base, as well as weights of the packets. Thus, the controller 31 of the server 3 can acquire, at step S1, a total weight of the large number of packets to be loaded at the distribution base.

At step S2, the controller 31 of the server 3 acquires information on a route on which the vehicle 2 moves based on points A, B, C, and D. Note that the order in which the vehicle 2 goes from point A to point B is determined without conditions. Whether to adopt a first route on which the vehicle 2 departs at point B, stops over at point C, and arrives at point D, or a second route on which the vehicle 2 departs at point B, stops over at point D, and arrives at point C can be determined by, for example, the time taken for delivery and the amount of energy consumption required to complete the delivery. It is assumed herein that the server 3 is configured, for example, to place greater importance on the amount of energy consumption than the time required to complete delivery.

During operation, the weight of the vehicle 2 is reduced by the weight of the first packet at point C, and is reduced by the weight of the second packet at point D. The controller 31 of the server 3 calculates a running resistance based on an elevation change (gradient) and a degree of decrease in packet weight, and outputs (predicts) an amount of energy consumption, with respect to each of the first and second routes (steps S3-S7).

The controller 31 of the server 3 is capable of outputting a route calculated to be optimum based on the energy consumption. This allows the controller 31 of the server 3 to present a high-precision operation schedule to the user of the vehicle 2.

Note that information obtained by a weight sensor attached to one or more of the vehicles 2a to 2n managed by the server 3, for example, may be used for the change in the total weight of the vehicle 2 on a route after the distribution base. The weight loaded into the vehicle 2 is reduced every time, for example, a packet is delivered to a delivery destination from the distribution base (point B).

The server 3 is capable of estimating a change in the weights of packets by, for example, obtaining information on the number of times of opening/closing of a door with an open/close sensor (not illustrated) attached to a mounting (freight compartment) of the vehicle 2 from the ECU 16 configured to control the open/close sensor. A weight change in the total weight of the vehicle 2 can be estimated using, for example, information at the time of moving and at the time of operation that can be obtained from, for example, the ECU 16 of the vehicle 2. The information on the weight of the vehicle 2 includes information indicating a weight change according to a weight of an object placed on the vehicle 2 moving on the scheduled moving route. In this manner, the server 3 may obtain, for example, a relationship between the number of packets to be delivered to the destination and the weight information of all the packets, and the relationship between the number of openings/closings of the door of the vehicle 2 and the weight of the packets. By using such information and calculating a running resistance based on a weight that decreases with every delivery destination, it is possible to provide an apparatus or server 3 for predicting energy consumption of the vehicle 2, a system 1 for predicting energy consumption of the vehicle 2, a method for predicting energy consumption of the vehicle 2, and a non-transitory storage medium storing a program for predicting energy consumption of the vehicle 2 capable of more accurately predicting energy consumption of the vehicle 2.

In the case where the vehicle 2 is a delivery vehicle, the number of times of loading of packets into the vehicle 2 is not limited to one, and new packets may be loaded into the vehicle 2 while packets are being delivered to suitable destinations. In this case, too, the server 3 is capable of more accurately predicting energy consumption of the vehicle 2 by suitably estimating the weights of packets to be loaded.

If the vehicle 2 includes a weight scale, for example, the vehicle 2 may predict, using the server 3, an amount of energy consumption required for the vehicle 2 to arrive at the destination after putting articles into a mounting, etc. of the vehicle 2.

Note that, if the vehicle 2 is a delivery vehicle, a weight of a pallet onto which packets are put, as well as the weight of the packets, may be obtained and used to calculate a running resistance of the vehicle 2 at a certain point in time.

In the case where an engine vehicle such as a diesel vehicle, a hybrid electric vehicle (HEV), a plug-in hybrid electric vehicle (PHEV), or a fuel cell electric vehicle (FCEV) is used as the above-described vehicle 2, in place of an EV, an engine may be used as a driving source in place of the motor 22. Furthermore, light oil, gasoline, or the like may be used as the energy source in place of the battery 20. Thus, the server (apparatus) 3 for predicting energy consumption of the vehicle 2 may be configured to predict power efficiency of an EV or fuel efficiency of an engine vehicle as the prediction of the energy consumption of the vehicle 2.

In the present embodiment, a description has been made of an example in which the server or apparatus 3 for predicting energy consumption of the vehicle 2 is realized by a single information processing server 3; however, it may be configured of a plurality of information processing servers 3 over which the functions are distributed.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An apparatus for predicting energy consumption, the apparatus including a processor configured to:
acquire information indicating a scheduled moving route of a vehicle;
specify a running resistance that will be applied to the vehicle when the vehicle moves on the scheduled moving route, based on the information indicating the scheduled moving route;
specify a moving output that will be required for driving of a driving source of the vehicle when the vehicle moves on the scheduled moving route, based on the information indicating the scheduled moving route; and
output, based on the running resistance and the moving output, an amount of energy consumption when the vehicle moves on the scheduled moving route.

2. The apparatus according to claim 1, wherein
the processor is configured to specify the running resistance when the vehicle moves on the scheduled moving route, based on information on a weight of the vehicle.

3. The apparatus according to claim 2, wherein
the information on the weight of the vehicle includes information indicating a weight change according to a weight of an object placed on the vehicle moving on the scheduled moving route.

4. The apparatus according to claim 2, wherein
the weight of the vehicle includes weights of a cab, a chassis, and a mounting of the vehicle,
wherein:
the chassis includes the driving source, and
the mounting is provided on the chassis.

5. The apparatus according to claim 1, wherein
the processor is configured to specify the running resistance based on at least one of an elevation or a road surface situation on the scheduled moving route.

6. The apparatus according to claim 1, wherein
the processor is configured to specify the running resistance based on at least one of a distance of the scheduled moving route, an average time required of the scheduled moving route, or an average vehicle speed of the scheduled moving route.

7. The apparatus according to claim 1, wherein
the processor is configured to specify the running resistance based on two or more of:
information on a weight of the vehicle when the vehicle moves on the scheduled moving route;
at least one of a distance of the scheduled moving route, an average time required of the scheduled moving route, or an average vehicle speed of the scheduled moving route; and
at least one of an elevation or a road surface situation on the scheduled moving route.

8. A system for predicting energy consumption, comprising:
the apparatus according to claim 1; and
a controller provided in the vehicle and configured to transmit, to the apparatus for predicting energy consumption, a state of the driving source of the vehicle and a state of a battery for supplying energy to drive the driving source.

9. A method for predicting energy consumption, comprising:
acquiring information indicating a scheduled moving route of a vehicle;
specifying a running resistance that will be applied to the vehicle when the vehicle moves on the scheduled moving route, based on the information indicating the scheduled moving route;
specifying a moving output that will be required for driving of a driving source of the vehicle when the vehicle moves on the scheduled moving route, based on the information indicating the scheduled moving route; and
outputting, based on the running resistance and the moving output, an amount of energy consumption when the vehicle moves on the scheduled moving route.

10. A non-transitory storage medium storing a program for predicting energy consumption by causing a computer to:
acquire information indicating a scheduled moving route of a vehicle;
specify a running resistance that will be applied to the vehicle when the vehicle moves on the scheduled moving route, based on information indicating the scheduled moving route;
specify a moving output that will be required for driving of a driving source of the vehicle when the vehicle moves on the scheduled moving route, based on the information indicating the scheduled moving route; and
output, based on the running resistance and the moving output, an amount of energy consumption at the time of moving of the vehicle on the scheduled moving route.
